(19) United States
(12) Patent Application Publication
(10) Pub. No.: US 2005/0115592 A1
(43) Pub. Date: Jun. 2, 2005

(54) Water guide of dishwasher and dishwasher having the same

(75) Inventor: Jae Hyuk Lee, Geumjeong-gu (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 10/966,102

(22) Filed: Oct. 18, 2004

(30) Foreign Application Priority Data
Oct. 16, 2003 (KR) 2003-72163

(51) Int. Cl. B08B 3/02

(52) U.S. Cl. 134/57 D; 134/58 D; 134/94.1; 134/186

(57) ABSTRACT

A water guide of a dishwasher and dishwasher having the same, by which clean water is prevented from being unexpectedly discharged, are disclosed. The water guide includes a drain passage communicating with a sump receiving a water therein and an external atmosphere, respectively, the drain passage configured to drain a used water, and a valve assembly provided to the drain passage, the valve assembly configured to prevent an unused water within the sump from being drained via the drain passage. Therefore, the reliability of the water guide of the dishwasher and the dishwasher having the same can be considerably enhanced.

This application claims the benefit of Korean Application No. 10-2003-0072163, filed on Oct. 16, 2003, which is hereby incorporated by reference.

### BACKGROUND OF THE INVENTION

1. Field of the Invention

The present invention relates to a dishwasher, and more particularly, to a water guide of a dishwasher, by which a flow of water used in the dishwasher is guided.

2. Discussion of the Related Art

Generally, a dishwasher is an appliance for washing and drying tableware automatically by injecting a detergent and water on the tableware. And, the dishwasher consists of at least one rack provided within a washing chamber to support tableware thereon, a sump storing water therein, at least one injector arranged under the rack to inject the water toward the tableware put on the rack, and a pump supplying the water stored within the sump to the injector.

Once the pump is activated, the injector injects the water within the sump onto the tableware to wash. And, the water injected on the tableware is recovered to the sump and is then injected toward the tableware again. After completion of a washing cycle, a drain pump is activated to discharge the water within the sump outside via drain hose. After the drain pump stops being operated, clean water is supplied to the sump for a rinsing cycle.

In the above-configured dishwasher, if the drain hose fails to be provided over a water level within the sump, a siphon phenomenon take place due to a pressure difference despite stopping operating the drain pump. The clean water having been supplied to the sump for the rinsing cycle is discharged via drain line consisting of the sump, drain pump, and drain hose. Hence, water consumption increases and the washing or rinsing is unable to be efficiently performed. It is not only difficult but also annoying for a user to install the drain hose over the sump water level each time the dishwasher is newly installed or moved to another place.

Moreover, even if the installation position of the drain hose is appropriately adjusted, a pressure within the drain line can be decreased lower than an atmospheric pressure by various factors during the operation of dishwasher. In such a case, the clean water could be unexpectedly discharged by the siphon phenomenon.

### SUMMARY OF THE INVENTION

Accordingly, the present invention is directed to a water guide of a dishwasher and dishwasher having the same that substantially obviate one or more of the problems due to limitations and disadvantages of the related art.

An object of the present invention, which has been devised to solve the foregoing problem, lies in providing a water guide of a dishwasher and dishwasher having the same, by which clean water is prevented from being unexpectedly discharged.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a water guide of a dishwasher, including a drain passage communicating with a sump receiving a water therein and an external atmosphere, respectively, the drain passage configured to drain a used water and a valve assembly provided to the drain passage, the valve assembly configured to prevent an unused water within the sump from being drained via the drain passage.

The drain passage is connected to a drain pump connected to the sump. The drain passage is connected to a drain hose. The drain passage includes a siphon passage for the sump. At least one portion of the drain passage is configured to pass through a position higher than a water level within the sump. And, the drain passage has a reversed ‘U’ type shape.

The valve assembly is configured to selectively introduce an external air into the drain passage. For this, the valve assembly is configured to selectively allow the drain passage to communicate with an external atmosphere. Specifically, the valve assembly is configured to isolate the drain passage from an external atmosphere on draining the used water. And, the valve assembly is configured to allow the drain passage to communicate with an external atmosphere after completion of draining the used water.

Moreover, the valve assembly is provided within an air passage communicating between the drain passage and an external atmosphere to selectively open/close the air passage. The valve assembly includes a first gate communicating with the external atmosphere, a second gate communicating with the drain passage, and a valve provided between the first and second gates, the valve ascending/descending to close/open the first gate.

The valve is configured to be lifted by the water discharged via the drain passage. And, the valve descends by a weight of the valve after draining the water.

The second gate is configured to constantly communicate with the drain passage. For this, the second gate is partially greater than the valve.

Meanwhile, the valve is configured to allow the second gate to constantly communicate with the drain passage. And, the valve is configured not to close the second gate.

For instance, the valve is formed smaller than the second gate to be configured to be caught on the second gate.

Moreover, the lowered valve is separated from the second gate to leave a prescribed distance from the second gate not to close the second gate. And, the lowered valve leaving the prescribed distance from the second gate can be lifted from the second gate. Alternatively, the lowered valve is configured to be suspended in the air passage.

In another aspect of the present invention, there is provided a dishwasher including a housing, a tub provided within the housing to receive tableware therein, a sump provided to the tub to receive water therein, an injector provided within the tub to inject the water within the sump to the tableware, a drain passage communicating with the sump and an external atmosphere, respectively, the drain passage configured to drain a used water, and a valve assembly provided to the drain passage, the valve assembly configured to prevent an unused water within the sump from being drained via the drain passage.

In the above-configured dishwasher, the water guide is provided with the foregoing-described features.

In the present invention having the above-described configurations, the water guide enables to prevent the water from being drained by the siphon phenomenon using the valve assembly.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a cross-sectional diagram of a dishwasher according to the present invention;

FIG. 2 is a cross-sectional diagram of a water guide of a dishwasher according to the present invention;

FIG. 3A and FIG. 3B are cross-sectional diagrams of explaining an operation of a water guide according to the present invention;

FIG. 4A is a perspective diagram of a valve within a water guide according to the present invention;

FIG. 4B is a cross-sectional diagram of an modification of a valve within a water guide according to the present invention;

FIG. 5A is a cross-sectional diagram of a modification of a gate included within a water guide according to the present invention;

FIG. 5B is a cross-sectional diagram according to a cutting line I-I in FIG. 5A;

FIG. 6A and FIG. 6B are perspective and cross-sectional diagrams of a modification of a valve within a water guide, respectively;

FIG. 7A and FIG. 7B are cross-sectional diagrams of modifications of a valve and gate within a water guide, respectively;

FIG. 8 is a cross-sectional diagram of a modification of a valve within a water guide; and

FIG. 9A and FIG. 9B are cross-sectional and perspective diagrams of a modification of a valve within a water guide, respectively.

### DETAILED DESCRIPTION OF THE PREFERRED EMBODIMENTS

Reference will now be made in detail to the preferred embodiments of the present invention, examples of which are illustrated in the accompanying drawings. Throughout the drawings, like elements are indicated using the same or similar reference designations where possible.

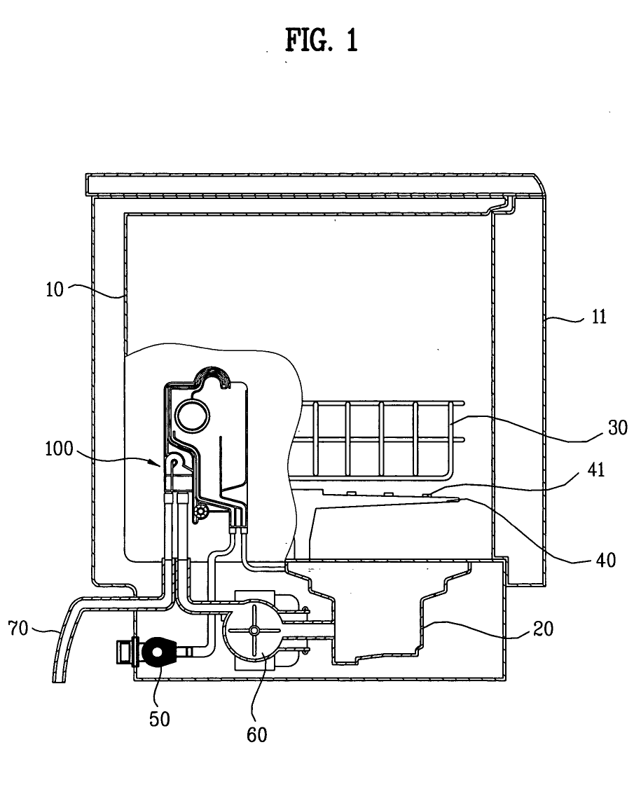

FIG. 1 is a cross-sectional diagram of a dishwasher including a water guide according to the present invention.

Referring to FIG. 1, in a dishwasher according to the present invention, a tub 10 forms a washing chamber that is opened or closed by a door 11 provided in front of the tub 10. And, at least one rack 30 is provided within the washing chamber to receive tableware therein. The rack 30 can be pulled out of the washing chamber when the door 11 is open. For instance, although one rack 30 is shown in FIG. 1, at least two racks can be provided to the washing chamber.

A sump 20 holding water therein is provided to a bottom part of the tub 10. The sump 20 preferentially holds clean water supplied from outside. A water guide 100 is connected to the sump 20 to guide a flow of the clean water to the sump 20. And, the sump 20 receives the polluted water falling downward after the tableware within the washing chamber has been washed. Moreover, a filter (not shown in the drawing) is connected to the sump 20 to filter the water polluted by the washing to reuse.

A pump (not shown in the drawing) is connected to the sump 20 to pump the water held within the sump 20 to an injector 40. The pump includes a motor (not shown in the drawing) connected to one side of the sump 20 and an impeller (not shown in the drawing) provided within the sump 20 to be connected to the motor. Hence, once the motor is activated, the impeller revolves to pump the water held within the sump 20 to the injector 40. The injector 40 is supplied with the water pumped by the pump and is generally provided beneath the rack 30. The injector 40 provided with at least one nozzle 41 so that the pumped water can be injected within the washing chamber via the nozzle 41. The injector 40 is rotatably installed and the nozzle 41 is oriented to tilt. Hence, the injector 40 is rotated by a reactive force exerted from the water that is jetted out of the nozzle 41 on the slant. Hence, the injected water is evenly sprinkled inside the washing chamber to cleanse the tableware put in the rack 30. The used or polluted water is retrieved to the sump 20 and is repeatedly injected into the washing chamber by the injector 40.

After completion of a plurality of washings or rinsings, the polluted water is drained from the sump 20 to be discharged outside the dishwasher. For this, a drain pump 60 is connected to the sump 20 and the water guide 100 is connected to the drain pump 60. And, a drain hose 70 is connected to the water guide 100 that guides a flow of the polluted water discharged outside from the sump 20. After completion of draining the polluted water, clean water is supplied to the sump 20 again via the water guide 100.

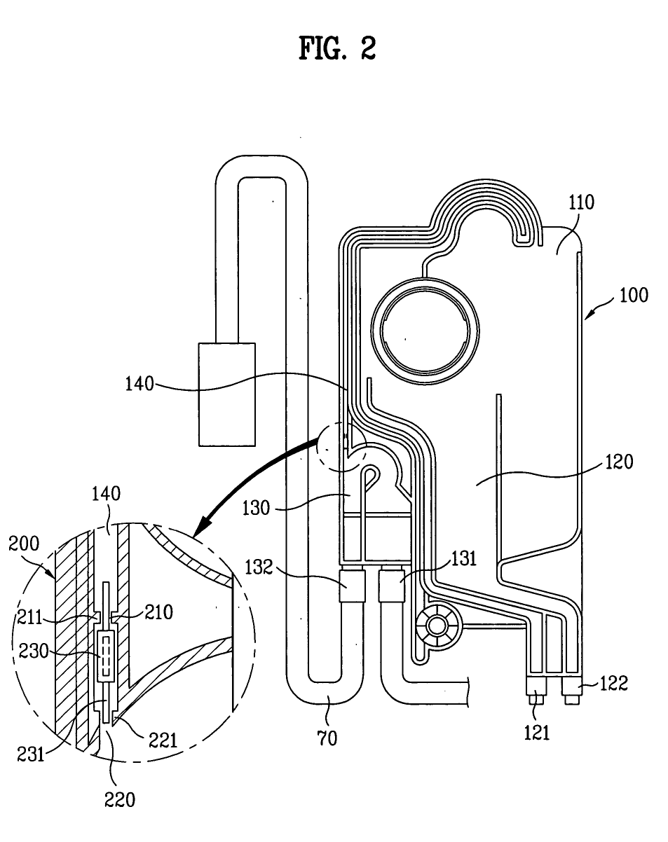

As mentioned in the foregoing description, the water guide 100 leads the polluted water drained from the sump 20 outside the dishwasher as well as guides the clean water supplied from outside to the sump 20. The water guide 100 is attached to an outer surface of the tub 10 and includes a water supply passage assembly and a drain passage assembly. The water guide 100 is applicable to all kinds of dishwashers and is explained in detail with reference to FIG. 2.

First of all, the water guide 100 includes a case attached to the tub 10 to provide an inner space inside. An air inlet 110 is provided to the water guide 100, e.g., an upper part of the water guide, to make the inner space and external atmosphere communicate with each other. And, a water supply passage 120 guiding the clean water and a drain passage 130 guiding the polluted water are provided to the inner space of the case.

The water supply passage 120 is connected to a water supply valve 50 shown in FIG. 1 and the sump 20 shown in FIG. 1, respectively. An inlet 121 and outlet 122 of the water supply passage 120, as shown in FIG. 2, are provided beneath the water guide 100. The inlet 121 is connected to the water supply valve 50, as shown in FIG. 1, and the outlet 122 is connected to the sump 20. Hence, once the water supply valve 50 is turned on, the clean water is supplied to the sump 20 via the water supply passage 120.

And, the drain passage 130 is connected to the drain pump 60 and the drain hose 70, respectively. The drain passage 130 is arranged next to the water supply passage 120 and includes an inlet 131 and outlet 132 provided beneath the water guide 100. The inlet 131, as shown in FIG. 1, is connected to the drain pump 60 communicating with the sump 20 and the outlet 132 is connected to the drain hose 70 communicating with outside the dishwasher. Hence, once the drain pump 60 is activated, the water within the sump 20 is drained outside via the drain pump 60, drain passage 130, and drain hose 70, in turn. Moreover, a portion of the drain passage 130, as shown in FIG. 1, is formed to pass through a position higher than a water level within the sump 20 (cf. FIG. 1). The drain passage 130, as shown in the drawing, has a reversed ‘U’ shape and substantially plays a role as a siphon passage for the sump 20. Since the drain passage 130 extends higher than the water level of the sump 20, it is able to prevent a drain phenomenon caused by a height difference between the water level of the sump 20 and a height of the drain hose 70. Namely, even if the drain pump 60 stops operating, the newly supplied water fails to keep being discharged from the sump 20 by the siphon phenomenon. Yet, the pressure within the drain passage 130 could be reduced lower than the atmospheric pressure working on the water within the sump 20 by various factors. The pressure difference from the atmospheric pressure within the drain passage 130 raises the water within the drain passage 130. In case of being raised by the pressure difference to be higher than a height between the water level of the sump 20 and a peak of the drain passage 130, the water is discharged outside by the siphon phenomenon via the drain passage 130 and the drain hose 70. Thus, for the above-explained reasons, the water, which is newly supplied after completion of the drain, can be discharged outside the dishwasher from the sump 20.

Hence, the water guide 100 according to the present invention includes a valve assembly 200 configured to prevent the unused water from being unnecessarily drained by the siphon phenomenon. As mentioned in the foregoing description, the siphon phenomenon occurs from the pressure difference between the drain passage 130 and the external atmosphere. In order to overcome the pressure difference, the valve assembly 200 is configured to optionally introduce external air into the drain passage 130. For the introduction of the external air, the valve assembly 200 makes the drain passage 130 to communicate with the external atmosphere selectively. Namely, in order to prevent the siphon phenomenon, the valve assembly 200 is configured to make the drain passage 130 communicate with the external atmosphere only when the used water is completely drained. Moreover, the siphon phenomenon should be overcome before the water arrives at the peak of the drain passage 130. Hence, the valve assembly 200 is preferably provided over the peak of the drain passage 130, i.e., an upper part of the drain passage 130. In other words, the valve assembly 200 is provided to or in the vicinity of a bent portion of the reversed ‘U’ type drain passage 130.

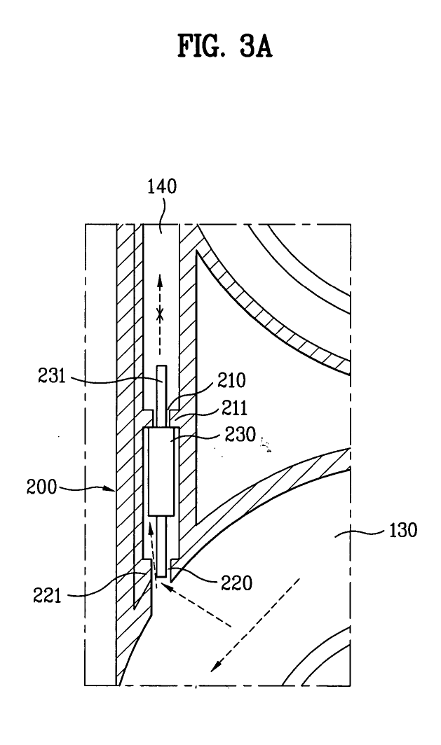

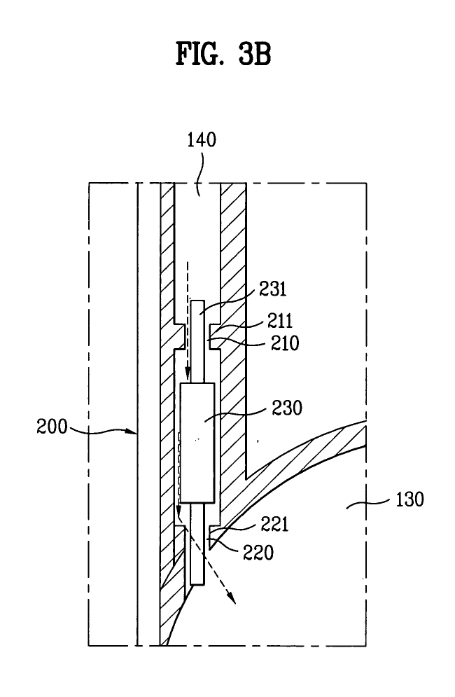

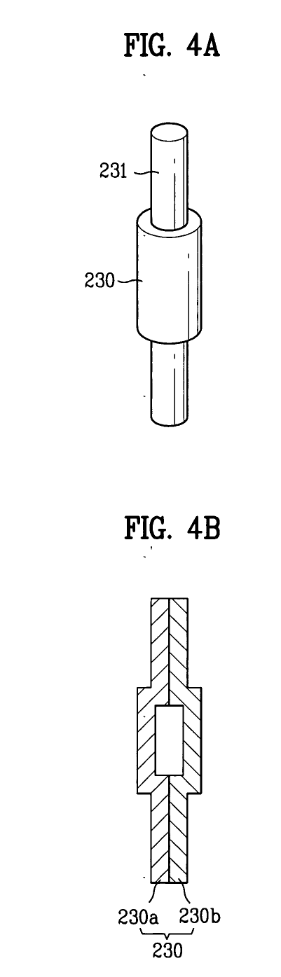

The valve assembly 200 is additionally explained in detail with reference to FIGS. 3A to 4B as follows.

The drain passage 120 needs to directly communicate with the external atmosphere for effective introduction of the external air. Hence, the drain passage 120 is connected to an air passage 140 communicating with the external atmosphere. The valve assembly 200 is substantially installed within the air passage 140 and selectively open/close the air passage 140 to control the introduction of the external air.

Specifically, the valve assembly 200 includes first and second gates 210 and 220 provided within the air passage 140 and a valve 230 provided between the first and second gates 210 and 220.

The first gate 210, as shown in the drawing, communicates with the external atmosphere, whereas the second gate 220 communicates with the drain passage 130. Hence, the external air is introduced into the drain passage 130 via the first and second gates 210 and 220 within the air passage 140. And, the first and second gates 210 and 220 are substantially configured with first and second ribs 210 and 220 extending from an inner surface of the air passage, respectively. The first and second ribs 210 and 220 play a role in supporting the valve 230 and putting limitation on the movement of the valve 230.

The valve 230 ascends/descends between the first and second gates 210 and 220 to close or open the first gate 210. The first gate 210 always has a size smaller than the valve 230 to be closed by the valve 230. In the present invention, the movement of the valve 230 is basically performed by the drained water. Specifically, once the drain pump 60 in FIG. 1 is activated, the used water within the sump 20 is introduced into the drain passage 130 via the inlet 131. The introduced water, which was pumped by the drain pump 60, is raised fast by the high pressure and then falls to be drained outside the dishwasher via the outlet 132 and the drain hose 70. During the draining, a portion of the water, as shown in FIG. 3A, is introduced into the air path 140 via the second gate 220. The valve 230 is then raised by the water to block the first gate 210. Namely, when the used water is drained, the valve assembly 200, and more specifically, the valve 230 is raised by the water to close the first gate 210 so that the drain passage 130 can be isolated from the external atmosphere. Consequently, the used water avoids leaking via the air path 140 but is drained outside via the drain passage 410 and the drain hose 70.

Once the drain pump 60 stops operating, an amount of the water reaming within the drain passage is abruptly reduced. The valve 230, as shown in FIG. 3B, descends due to its own weight so that the first gate 210 can be open. Namely, after completion of the drain of the used water, the valve 230 descends due to its weight to open the first gate 210 so that the drain passage 130 can communicate with the external atmosphere. Hence, the external air is quickly introduced into the drain passage 130 via the first and second gates 210 and 220. In doing so, the drain passage 130 remains in an atmospheric state to settle the pressure difference between the sump 20 and the drain passage 130, whereby the siphon phenomenon is removed. Consequently, once the drain pump 60 stops operating, the drain is automatically and completely stopped by the valve assembly 200.

Preferably, the valve 230 has buoyancy to be well raised by the water. Hence, the valve 230 may include a floating body formed of a material having the buoyancy. Alternatively, the valve 230 can include a hollow body to have the buoyancy. The hollow valve 230, as shown in FIG. 4B, can be easily provided using a pair of pieces 230a and 230b assembled to each other. Moreover, the valve 230, as shown in FIG. 4A, can further include an extension 231 extending in a length direction of the valve 230. The extension 231 is inserted in the first or second gate 210 or 220 according to its provided location. Since the extension 231 is guided by the first or second gate 210 or 220, the valve 230 enables to move stably. Hence, the extension 231 prevents a malfunction of the valve 230 and enhances reliability. Preferably, a pair of extensions 231 are provided to top and bottom of the valve 230 to be stably guided by the first and second gates 210 and 220, respectively.

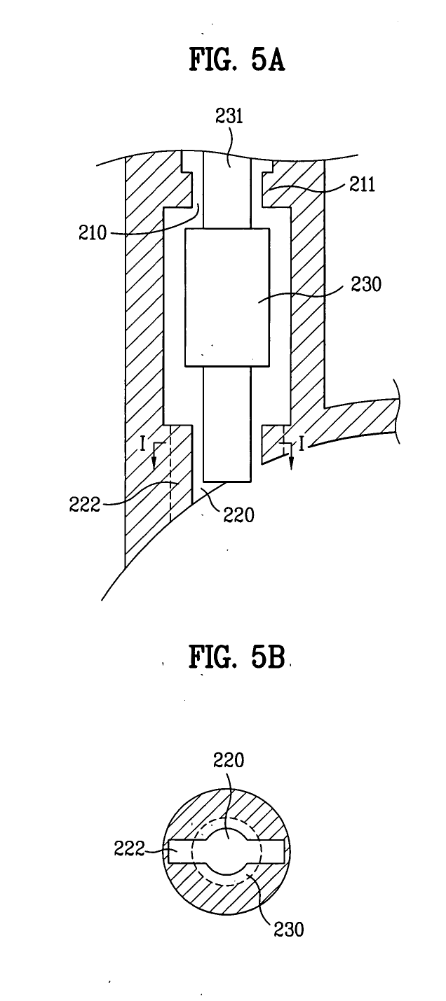

Meanwhile, if the second gate 220 is closed by the lowered valve 230 or other reasons, it is unable to supply the external air to the drain passage 130 to settle the pressure difference even if the first gate 210 is open. Hence, the second gate 220 needs to be constantly open to communicate with the drain passage 130. FIGS. 5A to 9B show various modifications for opening the second gate 220 constantly.

Referring to FIG. 5A and FIG. 5B, the second gate 229 itself is configured to constantly communicate with the drain passage 130. Namely, the second gate 220 is partially formed greater than the valve 230. If the second gate 220 is greater than the valve 230 overall, the second gate 220, and more precisely, the second rib 221 is unable to limit the movement of the valve 230. Specifically, the second gate 220, as shown in FIG. 5B, can further include an auxiliary gate 222 extending from the second gate 220 in a radial direction. Even if the valve 230 is lowered to be placed on the second gate 220 as indicated by the doted line in FIG. 5B, the second gate 220 enables to communicate with the drain passage 130 via the auxiliary gate 222. Hence, the external air can be introduced into the drain passage 130 via the first and auxiliary gates 210 and 222 even if the valve 230 is lowered.

Alternatively, in the present invention, the valve 230 is configured to allow the second gate 220 to constantly communicate with the drain passage 130. Namely, the valve 239 is configured not to close the second gate 220.

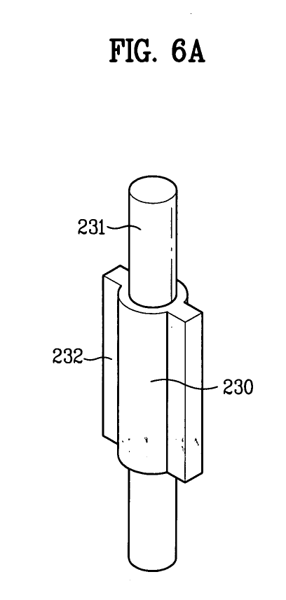

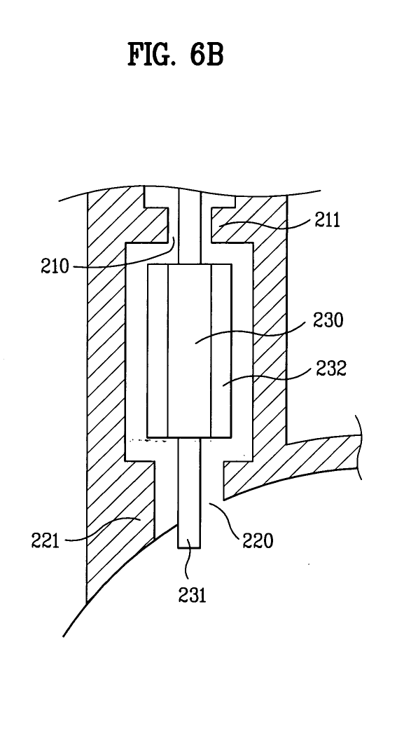

Referring to FIG. 6A and FIG. 6B, the valve 230 is formed smaller than the second gate 220 and is configured to be latched on the second gate 220 in case of descending. Specifically, a rib 232 is provided to a lateral side of the valve 230. The rib 232 is latched on the second rib 221 to put limitation on the descent of the valve 230 smaller than the second gate 220. Namely, the valve 230 is approximately smaller than the second gate 220 but is partially greater than the second gate 220 for the limited descent of the valve 230. Preferably, a pair of ribs 232, as shown in the drawing, are provided to the lateral side of the valve 230 so that the valve 230 can be stably supported by the second rib 221. In such a modification, even if the lowered valve 230 is put on the second rib 221, a clearance between the valve 230 and the second gate 220 still allows the second gate 220 to communicate with the drain passage 130. Hence, the external air can be introduced into the drain passage 130 via the open first gate 210 and the clearance.

Moreover, the valve 230 can be configured to leave a predetermined distance from the second gate in ascending not to close the second gate 220.

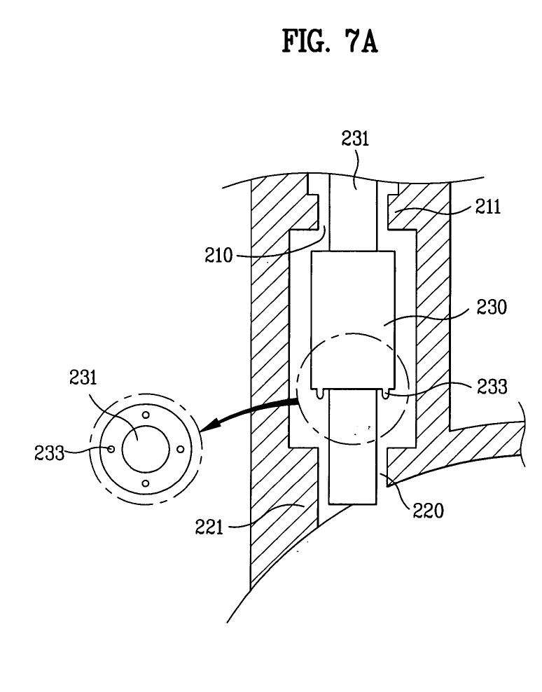

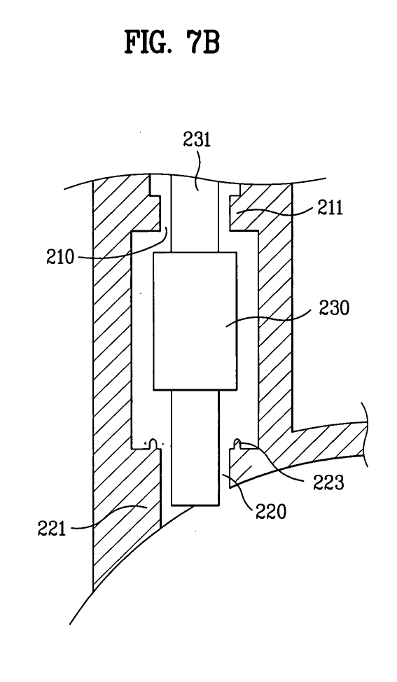

Referring to FIG. 7A and FIG. 7B, the lowered valve 230 is lifted from the second gate 220 to leave a prescribed distance from the second gate 220. Specifically, at least one protrusion 233, as shown in FIG. 7A, is provided to a lower end of the valve 230 or at least one protrusion 223, as shown in FIG. 7B, is provided to a periphery of the second gate 220, and more particularly, to the second rib 221. The protrusion 233 or 223 supports the lowered valve 230 to be lifted from the second gate 220. In such a modification, the lowered valve 230 is substantially separated from the second gate 220 so that a clearance is provided between the second gate 220 and the valve 230. The second gate 220 is constantly open by the clearance to communicate with the drain passage 130. Hence, once the first gate 210 is open, the external air can be introduced into the drain passage 130 via the first and second gates 210 and 220.

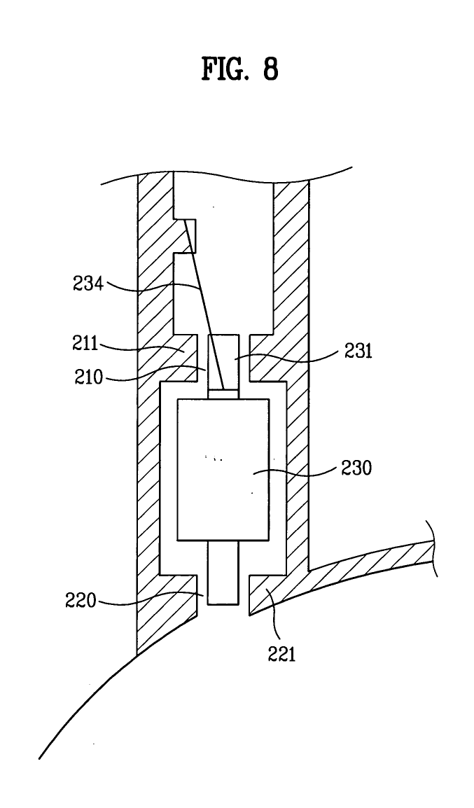

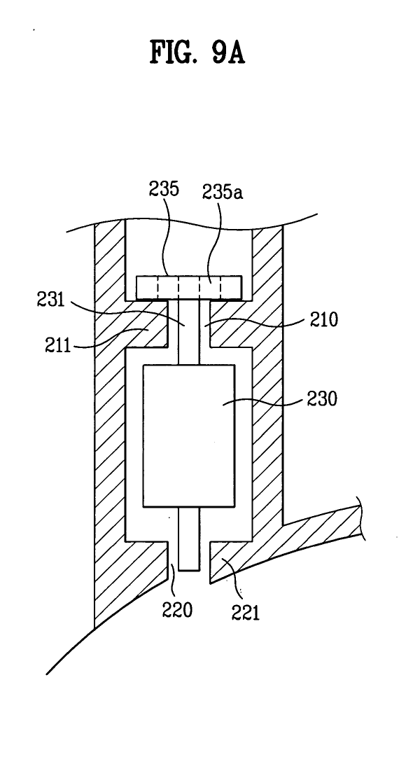

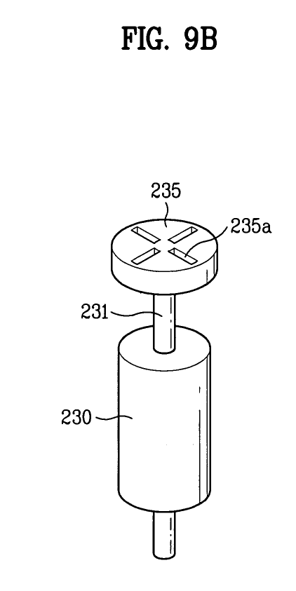

Moreover, the lowered valve 230 is configured to be suspended in the air passage 140 to be separated from the second gate 220. First of all, the lowered valve 230, as shown in FIG. 8, is configured to be suspended on a wall of the air passage 140. Specifically, the valve 230, as shown in FIG. 8, is connected to an inner surface of the air passage 140 by a wire 234. A length of the wire 234 is adjusted so that the valve 230 suspended by the wire 234 can avoid being contacted with the second rib 221. Alternatively, the lowered valve 230, as shown in FIG. 9A and FIG. 9B, can be configured to be suspended below the first gate 210. Specifically, the valve 230 includes an extension 235 extending from the valve 230 in a radial direction. The extension 235 is caught on the first gate 210 when the valve 230 is being lowered, whereby the valve 230 enables to be suspended below the first gate 210.

Meanwhile, when the valve 230 is lowered to open the first gate 210, the extension 235 may come into being caught on the first gate 210 to close the first gate 210. Hence, the extension 235 preferably includes at least one perforated hole 235a communicating with the first gate 210 to allow the external air to pass through. In the above-explained modifications, the lowered valve 230 is substantially separated from the second gate 220 by the wire 234 or the extension 235 so that the clearance can be provided between the second gate 220 and the valve 230. The second gate 220 is open to constantly communicate with the drain passage 130 via the clearance. Hence, once the first gate 210 is open, the external air can be introduced into the drain passage 130 via the first and second gates 210 and 220.

As mentioned in the foregoing description, the valve assembly according to the present invention enables to effectively prevent the clean water from being unexpectedly drained by the siphon phenomenon. Therefore, the reliability of the dishwasher can be considerably enhanced.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

1. A water guide of a dishwasher, comprising:
a drain passage communicating with a sump receiving a water therein and an external atmosphere, respectively, the drain passage configured to drain a used water; and
a valve assembly provided to the drain passage, the valve assembly configured to prevent an unused water within the sump from being drained via the drain passage.

2. The water guide of claim 1, wherein the drain passage is connected to a drain pump connected to the sump.

3. The water guide of claim 1, wherein the drain passage is connected to a drain hose.

4. The water guide of claim 1, wherein the drain passage comprises a siphon passage for the sump.

5. The water guide of claim 1, wherein at least one portion of the drain passage is configured to pass through a position higher than a water level within the sump.

6. The water guide of claim 1, wherein the drain passage has a reversed ‘U’ type shape.

7. The water guide of claim 1, wherein the valve assembly is provided over the drain passage.

8. The water guide of claim 1, wherein the valve assembly is provided to or in the vicinity of a bent portion of the drain passage.

9. The water guide of claim 1, wherein the valve assembly is configured to selectively introduce an external air into the drain passage.

10. The water guide of claim 1, wherein the valve assembly is configured to selectively allow the drain passage to communicate with an external atmosphere.

11. The water guide of claim 1, wherein the valve assembly is configured to isolate the drain passage from an external atmosphere on draining the used water.

12. The water guide of claim 1, wherein the valve assembly is configured to allow the drain passage to communicate with an external atmosphere after completion of draining the used water.

13. The water guide of claim 1, wherein the valve assembly is activated by the water drained via the drain passage.

14. The water guide of claim 1, wherein the valve assembly is provided within an air passage communicating between the drain passage and an external atmosphere to selectively open/close the air passage.

15. The water guide of claim 14, the valve assembly comprising:
a first gate communicating with the external atmosphere;
a second gate communicating with the drain passage; and
a valve provided between the first and second gates, the valve ascending/descending to close/open the first gate.

16. The water guide of claim 15, wherein the valve assembly further comprises first and second ribs extending from an inner surface of the air passage and wherein the first and second gates are provided to the first and second ribs, respectively.

17. The water guide of claim 15, wherein the valve is configured to be lifted by the water discharged via the drain passage.

18. The water guide of claim 15, wherein the valve descends by a weight of the valve after draining the water.

19. The water guide of claim 15, wherein the valve comprises a floating body.

20. The water guide of claim 15, wherein the valve comprises a hollow body.

21. The water guide of claim 15, wherein the valve further comprises an extension guided by at least one of the first and second gates.

22. The water guide of claim 15, wherein the second gate is configured to constantly communicate with the drain passage.

23. The water guide of claim 15, wherein the second gate is partially greater than the valve.

24. The water guide of claim 15, wherein the second gate comprises an auxiliary gate extending from the second gate.

25. The water guide of claim 15, wherein the valve is configured to allow the second gate to constantly communicate with the drain passage.

26. The water guide of claim 15, wherein the valve is configured not to close the second gate.

27. The water guide of claim 15, wherein the valve is formed smaller than the second gate to be configured to be caught on the second gate.

28. The water guide of claim 15, wherein the valve comprises a rib extending from the valve to be caught on the second gate.

29. The water guide of claim 15, wherein the lowered valve is separated from the second gate to leave a prescribed distance from the second gate.

30. The water guide of claim 15, wherein the lowered valve is lifted from the second gate.

31. The water guide of claim 15, wherein at least one protrusion is provided to a periphery of the second gate to support the lowered valve.

32. The water guide of claim 15, wherein at least one protrusion is provided to a lower tip of the valve to support the lowered valve.

33. The water guide of claim 15, wherein the lowered valve is suspended in the air passage.

34. The water guide of claim 15, wherein the lowered valve is configured to be hung on a wall of the air passage.

35. The water guide of claim 15, wherein the valve is connected to an inner surface of the air passage via a wire.

36. The water guide of claim 15, wherein the lowered valve is configured to be hung on the first gate.

37. The water guide of claim 15, wherein the valve further comprises an extension extending from the valve in a radial direction to be caught on the first gate on lowering the valve.

38. The water guide of claim 37, wherein the extension comprises at least one perforated hole.

39. A dishwasher comprising:
a housing;
a tub provided within the housing to receive tableware therein;
a sump provided to the tub to receive water therein;
an injector provided within the tub to inject the water within the sump to the tableware;
a drain passage communicating with the sump and an external atmosphere, respectively, the drain passage configured to drain a used water; and
a valve assembly provided to the drain passage, the valve assembly configured to prevent an unused water within the sump from being drained via the drain passage.

40. The dishwasher of claim 39, wherein the drain passage is connected to a drain pump connected to the sump.

41. The dishwasher of claim 39, wherein the drain passage is connected to a drain hose.

42. The dishwasher of claim 39, wherein the drain passage comprises a siphon passage for the sump.

43. The dishwasher of claim 39, wherein at least one portion of the drain passage is configured to pass through a position higher than a water level within the sump.

44. The dishwasher of claim 39, wherein the drain passage has a reversed ‘U’ type shape.

45. The dishwasher of claim 39, wherein the valve assembly is provided over the drain passage.

46. The dishwasher of claim 39, wherein the valve assembly is provided to or in the vicinity of a bent portion of the drain passage.

47. The dishwasher of claim 39, wherein the valve assembly is configured to selectively introduce an external air into the drain passage.

48. The dishwasher of claim 39, wherein the valve assembly is configured to selectively allow the drain passage to communicate with an external atmosphere.

49. The dishwasher of claim 39, wherein the valve assembly is configured to isolate the drain passage from an external atmosphere on draining the used water.

50. The dishwasher of claim 39, wherein the valve assembly is configured to allow the drain passage to communicate with an external atmosphere after completion of draining the used water.

51. The dishwasher of claim 39, wherein the valve assembly is activated by the water drained via the drain passage.

52. The dishwasher of claim 39, wherein the valve assembly is provided within an air passage communicating between the drain passage and an external atmosphere to selectively open/close the air passage.

53. The dishwasher of claim 39, the valve assembly comprising:
a first gate communicating with the external atmosphere;
a second gate communicating with the drain passage; and
a valve provided between the first and second gates, the valve ascending/descending to close/open the first gate.

54. The dishwasher of claim 53, wherein the valve assembly further comprises first and second ribs extending from an inner surface of the air passage and wherein the first and second gates are provided to the first and second ribs, respectively.

55. The dishwasher of claim 53, wherein the valve is configured to be lifted by the water discharged via the drain passage.

56. The dishwasher of claim 53, wherein the valve descends by a weight of the valve after draining the water.

57. The dishwasher of claim 53, wherein the valve comprises a floating body.

58. The dishwasher of claim 53, wherein the valve comprises a hollow body.

59. The dishwasher of claim 53, wherein the valve further comprises an extension guided by at least one of the first and second gates.

60. The dishwasher of claim 53, wherein the second gate is configured to constantly communicate with the drain passage.

61. The dishwasher of claim 53, wherein the second gate is partially greater than the valve.

62. The dishwasher of claim 53, wherein the second gate comprises an auxiliary gate extending from the second gate.

63. The dishwasher of claim 53, wherein the valve is configured to allow the second gate to constantly communicate with the drain passage.

64. The dishwasher of claim 53, wherein the valve is configured not to close the second gate.

65. The dishwasher of claim 53, wherein the valve is formed smaller than the second gate to be configured to caught on the second gate.

66. The dishwasher of claim 53, wherein the valve comprises a rib extending from the valve to be caught on the second gate.

67. The dishwasher of claim 53, wherein the lowered valve is separated from the second gate to leave a prescribed distance from the second gate.

68. The dishwasher of claim 53, wherein the lowered valve is lifted from the second gate.

69. The dishwasher of claim 53, wherein at least one protrusion is provided to a periphery of the second gate to support the lowered valve.

70. The dishwasher of claim 53, wherein at least one protrusion is provided to a lower tip of the valve to support the lowered valve.

71. The dishwasher of claim 53, wherein the lowered valve is suspended in the air passage.

72. The dishwasher of claim 53, wherein the lowered valve is configured to be hung on a wall of the air passage.

73. The dishwasher of claim 53, wherein the valve is connected to an inner surface of the air passage via a wire.

74. The dishwasher of claim 53, wherein the lowered valve is configured to be hung on the first gate.

75. The dishwasher of claim 53, wherein the valve further comprises an extension extending from the valve in a radial direction to be caught on the first gate on lowering the valve.

76. The dishwasher of claim 75, wherein the extension comprises at least one perforated hole.
